(19) United States
(12) Patent Application Publication
(10) Pub. No.: US 2018/0213288 A1
(43) Pub. Date: Jul. 26, 2018

(54) SYSTEMS AND METHODS FOR CREATING VIDEO COMPOSITIONS

(71) Applicant: GOPRO, INC., San Mateo, CA (US)

(72) Inventors: Jean Patry, Paris (FR); Guillaume Oules, Bordeaux (FR); Jean-Baptiste Noel, San Mateo, CA (US); Pierre-Elie Keslassy, San Mateo, CA (US)

(21) Appl. No.: 15/476,878

(22) Filed: Mar. 31, 2017

Related U.S. Application Data
(60) Provisional application No. 62/450,882, filed on Jan. 26, 2017.

(51) Int. Cl. H04N 21/472; G11B 27/10; G11B 27/029; G11B 27/036; H04N 1/00

(52) U.S. Cl. CPC H04N 21/47205; G11B 27/10; H04N 1/00167; H04N 21/47217; G11B 27/036; G11B 27/029

(57) ABSTRACT

Video information defining video content may be accessed. One or more highlight moments in the video content may be identified. One or more video segments in the video content may be identified based on one or more highlight moments. Derivative video information defining one or more derivative video segments may be generated based on one or more video segments. The derivative video information may be transmitted over a network to a computing device. One or more selections of the derivative video segments may be received from the computing device. Video information defining one or more video segments corresponding to one or more selected derivative video segments may be transmitted to the computing device. The computing device may generate video composition information defining a video composition based on the video information defining one or more video segments corresponding to one or more selected derivative video segments.

### FIELD

This disclosure relates to systems and methods that create video compositions.

### BACKGROUND

High quality video content may be stored in a cloud storage. A user may wish to create a video composition from the video content. However, downloading the video content from the cloud storage to review the video content may take a long time and take a large amount of bandwidth/storage space. Additionally, only small segments of the video content may be of interest to the user for inclusion in the video composition.

### SUMMARY

This disclosure relates to creating video compositions. Video information defining video content may be accessed. One or more highlight moments in the video content may be identified. One or more video segments in the video content may be identified based on the one or more highlight moments. Derivative video information defining one or more derivative video segments may be generated based on the one or more video segments. The derivative video information may be transmitted over a network to a computing device. One or more selections of the derivative video segments may be received from the computing device. Video information defining one or more video segments corresponding to the one or more selected derivative video segments may be transmitted to the computing device. The computing device may generate video composition information defining a video composition based on the video information defining the one or more video segments corresponding to the one or more selected derivative video segments.

A system that creates video compositions may include one or more of physical storage media, processors, and/or other components. The physical storage media may store video information defining video content. Video content may refer to media content that may be consumed as one or more videos. Video content may include one or more videos stored in one or more formats/container, and/or other video content. The video content may have a progress length. In some implementations, the video content may include one or more of spherical video content, virtual reality content, and/or other video content.

The processor(s) may be configured by machine-readable instructions. Executing the machine-readable instructions may cause the processor(s) to facilitate creating video compositions. The machine-readable instructions may include one or more computer program components. The computer program components may include one or more of an access component, a highlight moment component, a video segment component, a derivative video segment component, a communication component, and/or other computer program components.

The access component may be configured to access the video information defining one or more video content and/or other information. The access component may access video information from one or more storage locations. The access component may be configured to access video information defining one or more video content during acquisition of the video information and/or after acquisition of the video information by one or more image sensors.

The highlight moment component may be configured to identify one or more highlight moments in the video content. One or more highlight moments may include a first highlight moment, and/or other highlight moments. In some implementations, one or more highlight moments may be identified based on one or more highlight indications set during capture of the video content and/or other information. In some implementations, one or more highlight moments may identified based on metadata characterizing capture of the video content. In some implementations, one or more highlight moments may be changed based on one or more user interactions with the computing device and/or other information.

The video segment component may be configured to identify one or more video segments in the video content. One or more video segments may be identified based on one or more highlight moments and/or other information. Individual video segment may comprise one or more portions of the video content including one or more highlight moments. One or more video segments may include a first video segment and/or other video segments. The first video segment may comprise a first portion of the video content including the first highlight moment, and/or other portions of the video content.

The derivative video segment component may be configured to generate derivative video information defining one or more derivative video segments. Derivative video information may be generated based on one or more video segments. Individual derivative video segments may correspond to and may be generated from individual video segments. Individual derivative video segments may be characterized by lower fidelity than the corresponding individual video segments. Lower fidelity may include one or more of lower resolution, lower framerate, higher compression, and/or other lower fidelity.

One or more derivative video segments may include a first derivative video segment and/or other derivative video segments. The first derivative video segment may correspond to and may be generated from the first video segment. The first derivative video segment may be characterized by lower fidelity than the first video segment.

The communication component may be configured to transmit information to and receive information from one or more computing devices over a network. The communication component may be configured to transmit over a network derivative video information defining one or more derivative video segments and/or other information to a computing device. In some implementations, transmitting the derivative video information to the computing device may include streaming derivative video segments to the computing device.

The communication component may be configured to receive over the network one or more selections of the derivative video segments and/or other information from the computing device. In some implementations, an ordering of one or more selected derivative video segments may be determined and/or changed based on one or more user interactions with the computing device and/or other information. In some implementations, one or more portions of the video content comprised in one or more video segments may be changed based on one or more user interactions with the computing device and/or other information.

The communication component may be configured to transmit over the network video information defining one or more video segments corresponding to one or more selected derivative video segments and/or other information to the computing device. The computing device may generate video composition information defining a video composition based on the video information defining one or more of the video segments corresponding to one or more selected derivative video segments. In some implementations, the video composition information may be generated by the computing device further based on the ordering of one or more selected derivative video segments. In some implementations, the video composition may be changed based on one or more user interactions with the computing device and the video information defining one or more video segments corresponding to one or more selected derivative video segments and transmitted to the computing device.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system that creates video compositions.

FIG. 2 illustrates a method for creating video compositions.

FIG. 3 illustrates exemplary system that includes computing devices, a server, and a network for creating video compositions.

FIG. 4 illustrates exemplary process flows of a server and a computing device for creating video compositions.

FIG. 5A illustrates exemplary highlights moments within video content.

FIGS. 5B-5D illustrate exemplary video segments identified based on highlight moments shown in FIG. 5A.

FIG. 6A illustrates exemplary changed highlights moments within video content.

FIG. 6B illustrates exemplary video segments identified based on highlight moments shown in FIG. 6A.

FIG. 6C illustrates exemplary changed video segments.

FIG. 7A illustrates exemplary selection of derivative video segments for inclusion in a video composition.

FIG. 7B illustrates exemplary changed order of derivative video segments selected for inclusion in a video composition.

FIGS. 8-9 illustrate exemplary interfaces for creating video compositions.

### DETAILED DESCRIPTION

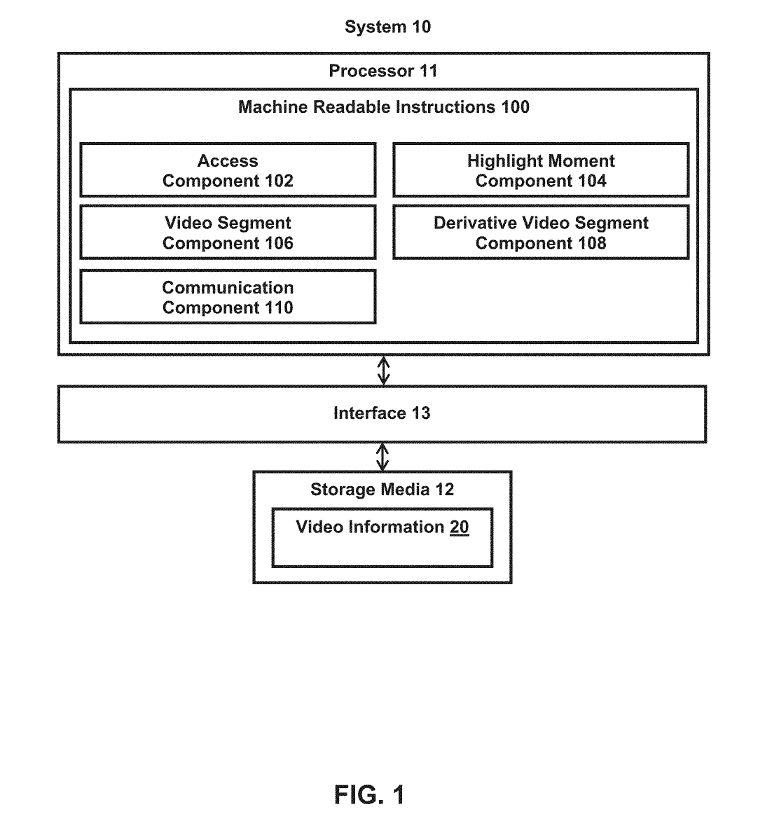

FIG. 1 illustrates system 10 for creating video compositions. System 10 may include one or more of processor 11, storage media 12, interface 13 (e.g., bus, wireless interface), and/or other components. Video information 20 defining video content may be accessed by processor 11. One or more highlight moments in the video content may be identified. One or more video segments in the video content may be identified based on the one or more highlight moments. Derivative video information defining one or more derivative video segments may be generated based on the one or more video segments. The derivative video information may be transmitted over a network to a computing device. One or more selections of the derivative video segments may be received from the computing device. Video information 20 defining one or more video segments corresponding to the one or more selected derivative video segments may be transmitted to the computing device. The computing device may generate video composition information defining a video composition based on the video information defining the one or more video segments corresponding to the one or more selected derivative video segments.

Storage media 12 may be configured to include electronic storage medium that electronically stores information. Storage media 12 may store software algorithms, information determined by processor 11, information received remotely, and/or other information that enables system 10 to function properly. For example, storage media 12 may store information relating to video information, derivative video information, video content, highlight moments, video segments, derivative video segments, computing devices, video compositions, and/or other information.

Storage media 12 may store video information 20 defining one or more video content. Video content may refer to media content that may be consumed as one or more videos. Video content may include one or more videos stored in one or more formats/container, and/or other video content. A video may include a video clip captured by a video capture device, multiple video clips captured by a video capture device, and/or multiple video clips captured by separate video capture devices. A video may include multiple video clips captured at the same time and/or multiple video clips captured at different times. A video may include a video clip processed by a video application, multiple video clips processed by a video application and/or multiple video clips processed by separate video applications.

Video content may have a progress length. A progress length may be defined in terms of time durations and/or frame numbers. For example, video content may include a video having a time duration of 60 seconds. Video content may include a video having 1800 video frames. Video content having 1800 video frames may have a play time duration of 60 seconds when viewed at 30 frames/second. Other time durations and frame numbers are contemplated.

In some implementations, video content may include one or more of spherical video content, virtual reality content, and/or other video content. Spherical video content may refer to a video capture of multiple views from a single location. Spherical video content may include a full spherical video capture (360 degrees of capture) or a partial spherical video capture (less than 360 degrees of capture). Spherical video content may be captured through the use of one or more cameras/image sensors to capture images/videos from a location. The captured images/videos may be stitched together to form the spherical video content.

Virtual reality content may refer to content that may be consumed via virtual reality experience. Virtual reality content may associate different directions within the virtual reality content with different viewing directions, and a user may view a particular directions within the virtual reality content by looking in a particular direction. For example, a user may use a virtual reality headset to change the user's direction of view. The user's direction of view may correspond to a particular direction of view within the virtual reality content. For example, a forward looking direction of view for a user may correspond to a forward direction of view within the virtual reality content.

Spherical video content and/or virtual reality content may have been captured at one or more locations. For example, spherical video content and/or virtual reality content may have been captured from a stationary position (e.g., a seat in a stadium). Spherical video content and/or virtual reality content may have been captured from a moving position (e.g., a moving bike). Spherical video content and/or virtual reality content may include video capture from a path taken by the capturing device(s) in the moving position. For example, spherical video content and/or virtual reality content may include video capture from a person walking around in a music festival.

Referring to FIG. 1, processor 11 may be configured to provide information processing capabilities in system 10. As such, processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. Processor 11 may be configured to execute one or more machine readable instructions 100 to facilitate creating video compositions. Machine readable instructions 100 may include one or more computer program components. Machine readable instructions 100 may include one or more of access component 102, highlight moment component 104, video segment component 106, derivative video segment component 108, communication component 110, and/or other computer program components.

Access component 102 may be configured to access video information defining one or more video content and/or other information. Access component 102 may access video information from one or more storage locations. A storage location may include storage media 12, electronic storage of one or more image sensors (not shown in FIG. 1), and/or other locations. For example, access component 102 may access video information 20 stored in storage media 12. Access component 102 may be configured to access video information defining one or more video content during acquisition of the video information and/or after acquisition of the video information by one or more image sensors. For example, access component 102 may access video information defining a video while the video is being captured by one or more image sensors. Access component 102 may access video information defining a video after the video has been captured and stored in memory (e.g., storage media 12).

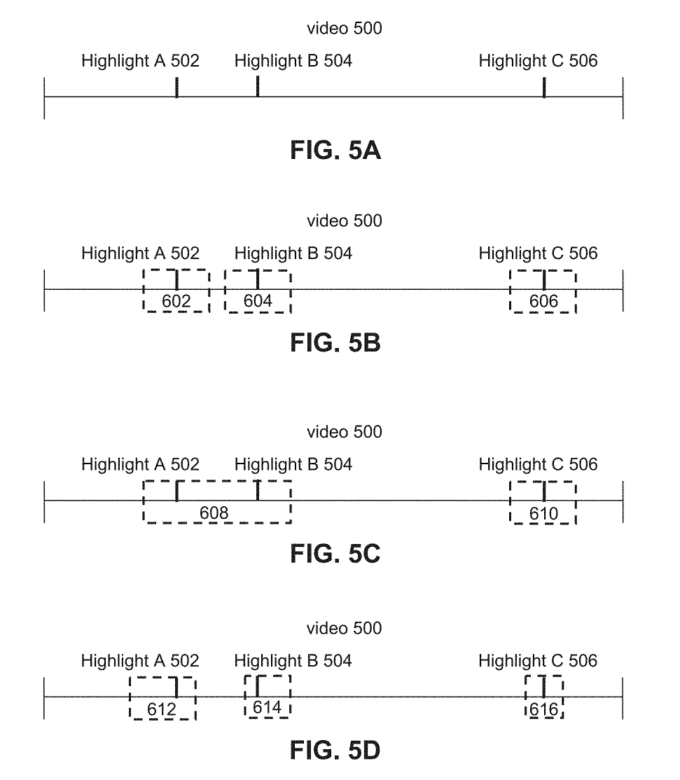

Highlight moment component 104 may be configured to identify one or more highlight moments in the video content. A highlight moment may correspond to a moment or a duration within the video content. A highlight moment may indicate an occurrence of one or more events of interest. For example, FIG. 5A illustrates exemplary highlight A 502, highlight B 504, and highlight C 506 identified within video 500. Individual highlights 502, 504, 506 may indicate that one or more events of interest occurred during the corresponding moment/duration during the capture of video 500.

In some implementations, one or more highlight moments may be identified based on one or more highlight indications set during capture of the video content and/or other information. For example, during capture of video 500, a user of or near the camera that captured video 500 may indicate that a highlight moment has occurred, is occurring, or will occur via one or more inputs (e.g., voice command, use of physical interface such as a physical button or a virtual button on a touchscreen display, particular motion of the user and/or the camera) into the camera. In some implementations, one or more highlight moments may identified based on metadata characterizing capture of the video content. For example, based on motion, location, and/or orientation data during the capture of video 500 by a camera, the camera may determine that a highlight moment has occurred, is occurring, or will occur. For example, a highlight moment may be identified based on the metadata indicating that a person has jumped or is accelerating. In some implementations, one or more highlight moments may be identified based on visual and/or audio analysis of the video content. For example, one or more highlight moments may be identified based on analysis of video 500 that looks for particular visuals and/or audio captured within video 500. In some implementations, a user may be presented with an option to confirm one or more highlight moments automatically detected within the video content.

Video segment component 106 may be configured to identify one or more video segments in the video content. One or more video segments may be identified based on one or more highlight moments and/or other information. Individual video segment may comprise one or more portions of the video content including one or more highlight moments. For example, FIGS. 5B-5D illustrate exemplary video segments identified based on highlight moments shown in FIG. 5A. In FIG. 5B, video segment component 106 may identify video segments 602, 604, 606 based on highlights 502, 504, 506. Video segments 602, 604, 606 may include a portion of video 500 including a highlight moment. Video segments 602, 604, 606 may be of equal duration (e.g., contain the same number of video frames). Video segments 602, 604, 606 may be centered on individual highlight moments 502, 504, 506. The duration of individual video segments may be determined based on system setting, user setting, capture setting, video capture metadata, captured activity, highlight indication, synced music (e.g., duration, rhythm, low-points, high-points), and/or other information.

In FIG. 5C, video segment component 106 may identify video segments 608, 610 based on highlights 502, 504, 506 Video segments 608, 610 may include a portion of video 500 including a highlight moment. Video segment 610 may be of same duration as video segment 606. Video segment 608 may be of longer duration than the combination of video segments 602, 604. Video segment component 106 may identify video segment 608 (rather than video segments 602, 604) based on the proximity of highlight A 502 and highlight B 504, based on the proximity of video segments 602, 604, and/or based on other information. In some implementations, video segment component 106 may combine video segments based on the identified video segments overlapping in at least a portion of the durations.

In FIG. 5D, video segment component 106 may identify video segments 612, 614, 616 based on highlights 502, 504, 506 Video segments 612, 614, 616 may include a portion of video 500 including a highlight moment. Video segments 612, 614, 616 may be of different durations. Video segments 612, 614 may not be centered on individual highlight moments 502, 504 and video segment 616 may be centered on highlight C 506. The amounts of duration by which a video segment (e.g., 612, 614, 616) includes video 500 preceding the highlight moment and following the highlight moment may be determined based on system setting, user setting, capture setting, video capture metadata, captured activity, highlight indication, synced music (e.g., duration, rhythm, low-points, high-points) and/or other information.

In some implementations, video segment component 106 may identify video segments for video content without highlight moments. For video content without highlight moments, video segment component 106 may divide the video content into video segments of equal duration. Providing to computing device(s) video segments for video content without highlight moments may enable users to set highlight moments for the video content/video segments.

Derivative video segment component 108 may be configured to generate derivative video information defining one or more derivative video segments. Derivative video information may be generated based on one or more video segments and/or other information. Individual derivative video segments may correspond to and may be generated from individual video segments. Individual derivative video segments may be characterized by lower fidelity than the corresponding individual video segments. Lower fidelity may include one or more of lower resolution, lower framerate, higher compression, and/or other lower fidelity.

For example, with respect to FIG. 5B, derivative video segment component 108 may generate derivative video information defining derivative video segments corresponding to and generated from video segments 602, 604, 606. Derivative video segments corresponding to and generated from video segments 602, 604, 606 may be characterized by lower fidelity than video segments 602, 604, 606.

With respect to FIG. 5C, derivative video segment component 108 may generate derivative video information defining derivative video segments corresponding to and generated from video segments 608, 610. Derivative video segments corresponding to and generated from video segments 608, 610 may be characterized by lower fidelity than video segments 608, 610.

With respect FIG. 5D, derivative video segment component 108 may generate derivative video information defining derivative video segments corresponding to and generated from video segments 612, 614, 616. Derivative video segments corresponding to and generated from video segments 612, 614, 616 may be characterized by lower fidelity than video segments 612, 614, 616.

Communication component 110 may be configured to transmit information to and receive information from one or more computing devices over a network. Communication component 110 may be configured to transmit over a network derivative video information defining one or more derivative video segments and/or other information to one or more computing devices. A computing device may refer to a device including a processor and a display that can receive video information over a network and present the video segments/derivative video segments defined by the video information/derivative video information on the display. The computing device may enable one or more users to select one or more derivative video segments for inclusion in a video composition. The computing device may enable one or more users to change the highlight moments, the derivative video segments, and/or other properties of the video composition. In some implementations, transmitting the derivative video information to the computing device may include streaming derivative video segments to the computing device. Use of derivative video information to present previews of the video segments on the computing device may shorten the time needed for a user to view the video segments that may be selected for inclusion in a video composition. Use of derivative video information to present previews of the video segments on the computing device may enable a user to more quickly select the portion of the video content from which the user decides to make the video composition.

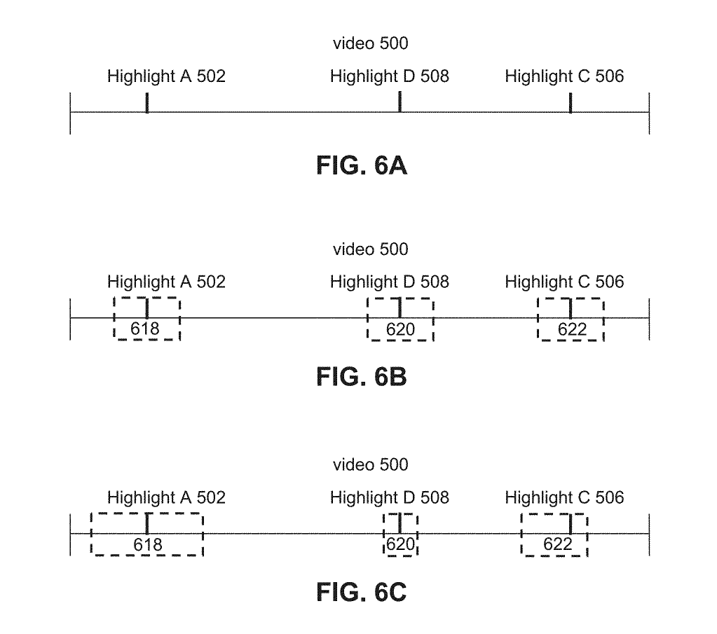

In some implementations, communication component 110 may be configured to receive over the network one or more changes to highlight moments and/or other information from the computing device. One or more highlight moments may be changed based on one or more user interactions with the computing device and/or other information. For example, FIG. 6A may illustrate exemplary changes to highlight moments in video 500 based on one or more user interactions with the computing device. As shown in FIG. 6A, a user may have interacted with the computing device to move highlight A 502 to a time/frame location earlier in video 500, remove highlight B 504, and added highlight D 508 between highlight A 502 and highlight C 506. Other changes in highlight moments are contemplated.

Video segment component 106 may identify video segments based on the changed highlight moments and/or change the identified video segments based on the changed highlight moments. For example, FIG. 6B illustrates video segments for highlight moments shown in FIG. 6A. Based on changes to the highlight moments in video 500, video segment component 106 may identify video segments 618, 620, 622. Based on changes to the highlight moments in video 500, video segment component 106 may change the identified video segments (e.g., 602, 604, 606) into new video segments 618, 620, 622.

In some implementations, one or more portions of the video content comprised in one or more video segments may be changed based on one or more user interactions with the computing device and/or other information. For example, FIG. 6C illustrates exemplary changes to video segments based on one or more user interactions with the computing device. As shown in FIG. 6C, a user may have interacted with the computing device to increase the amount of video 500 comprised in video segment 618, reduced the amount of video 500 comprised in video segment 620, and shifted the amount of video 500 comprised in video segment 520.

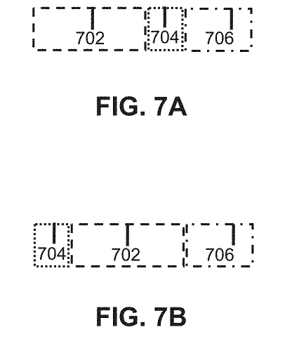

Communication component 110 may be configured to receive over the network one or more selections of the derivative video segments for inclusion in a video composition and/or other information from the computing device. For example, FIG. 7A illustrates exemplary selection of derivative video segments for inclusion in a video composition. As shown in FIG. 7A, a user may have selected derivative video segments 702, 704 706 for inclusion in the video composition. Derivative video segments 702, 704, 706 may correspond to and may be generated from video segments 618, 620, 622. A user may select one or more derivative video segments via interaction with one or more physical buttons (e.g., buttons on a camera, mobile device) or one or more areas of a touchscreen display (e.g., buttons on a touchscreen display, icons/previews representing derivative video segments).

In some implementations, the ordering of one or more selected derivative video segments may be determined and/or changed based on one or more user interactions with the computing device and/or other information. For example, a user may select derivative video segments 702, 704, 706 for inclusion in a video composition in the order of derivative video segment 702, derivative video segment 704, and derivative video segment 706. The user may change the ordering of the derivative video segments via interaction with one or more physical buttons (e.g., buttons on a camera, mobile device) or one or more areas of a touchscreen display (e.g., buttons on a touchscreen display, icons/previews representing derivative video segments). For example, referring to FIG. 7B, a user may change the ordering of derivative video segments 702, 704, 706 shown in FIG. 7A so that derivative video segments 702, 704, 706 are selected for inclusion in the video composition in the order of derivative video segment 704, derivative video segment 702, and derivative video segment 706.

Communication component 110 may be configured to transmit over the network video information defining one or more video segments corresponding to one or more selected derivative video segments and/or other information to the computing device. For example, responsive to receiving the user's selection of derivative video segments 702, 704, 706 for inclusion in a video composition, communication component 110 may transmit over the network video information defining video segments 618, 620, 622. In some implementations, video information defining video segments may be transmitted to the computing device upon receiving selection of individual derivative video segments. In some implementations, video information defining video segments may be transmitted to the computing device upon receiving indication from the computing device that the selection of derivative video segments has been completed.

For example, referring to FIG. 7A, a user may have selected derivative video segments for inclusion in the video composition by first selection derivative video segment 704, then selecting derivative video segment 702, and then selecting derivative video segment 702. Communication component 110 may transmit to the computing device video information defining video segment 620 upon receiving selection of derivative video segment 704. Communication component 110 may then transmit to the computing device video information defining video segment 618 upon receiving selection of derivative video segment 702. Communication component 110 may then transmit to the computing device video information defining video segment 622 upon receiving selection of derivative video segment 706. Communication component 110 may transmit to the computing device video information defining video segments 618, 620, 622 upon receiving indication from the computing device that the selection of derivative video segments has been completed.

The computing device (e.g., 301, 302) may generate video composition information defining a video composition based on the received video information. The received video information may defining one or more video segments corresponding to one or more selected derivative video segments. The computing device may encode the video composition based on a system setting, a user setting, and/or other information. The video composition information may be generated by the computing device further based on the ordering of one or more selected derivative video segments. For example, the video composition information generated based on the ordering of the selected derivative video segments shown in FIG. 7A may be different from the video composition information generated based on the ordering of the selected derivative video segments shown in FIG. 7B.

In some implementations, the video composition may include user-provided content. User provided content may refer to visual and/or audio content provided/selected by the user for inclusion in the video composition. For example, the user of the computing device may select one or more of text, image, video, music, sound, and/or other user-provided content for inclusion in the video composition.

In some implementations, the video composition/the video composition information may be changed based on one or more user interactions with the computing device. Changes to the video composition may include changes to the highlight moments (adding, removing, moving highlight moments), changes in the portion of the video content included in the video segments, changes in the ordering of the video segments, changes in the speed at which one or more portions of the video composition are played, changes in the inclusion of user-provided content, and/or other changes.

Because the video information defining the video segments within the video composition has been transmitted to the computing device, the computing device may make changes to the video composition using the received video information and without receiving additional/other video information. In some implementations, the computing device may request additional/other video information defining other portions of the video content based on the changes to the video composition requiring video information defining not yet received video segments. The computing device may generate changed video composition information using the previously received video information and newly received video information.

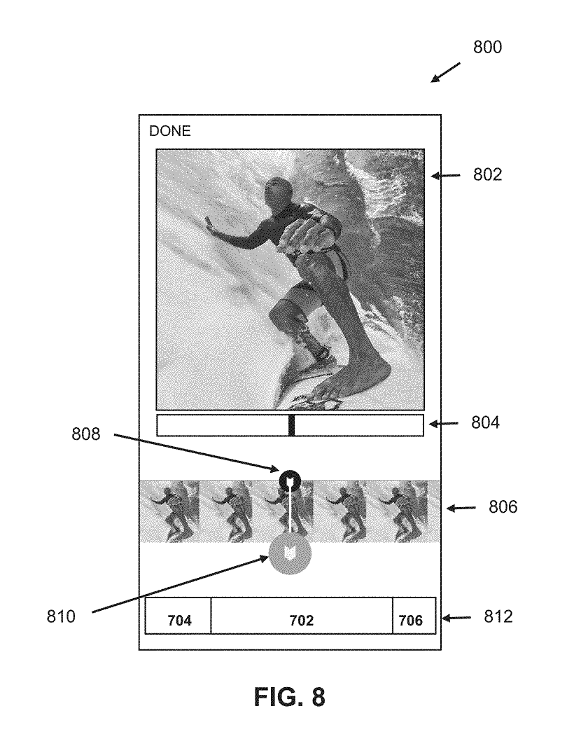

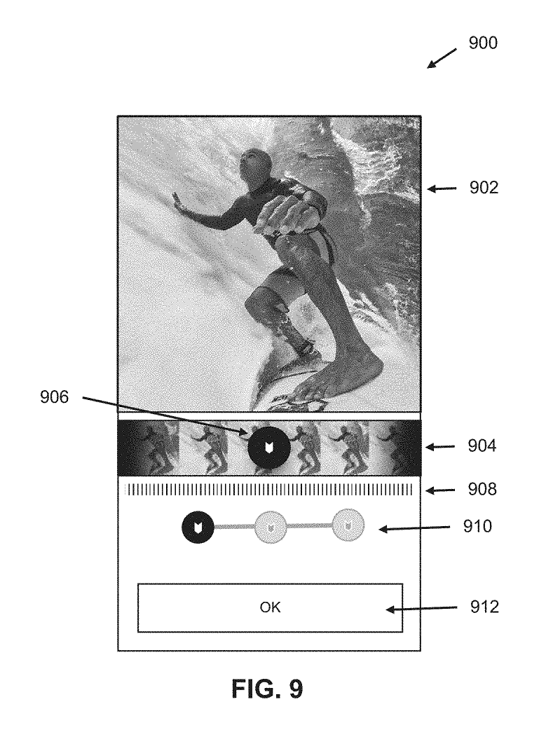

FIGS. 8-9 illustrate exemplary interfaces 800, 900 for creating video compositions. Other interface are contemplated. Referring to FIG. 8, interface 800 may enable a user to select one or more derivative video segments/highlight moments for inclusion in a video composition. Interface 800 may include viewing area 802 for viewing derivative video segments. The derivative video segments may be viewed as previews of the corresponding video segments. Interface 800 may include progress bar 804 indicating the location of the viewed portion with respect to the duration of the video content. Interface 800 may include frame viewing area 806 that shows previews of individual video frames of the derivative video segments.

Interface 800 may include highlight indicator 808 indicating the location of a highlight moment within the video content/video segment and highlight creator 810 which may be used to set a highlight moment within the video content/video segment. Highlight creator 810 may include a white line that extends vertically across the previews of video frames. A user may move the video frames of the video content/video segment behind highlight creator 810 and interact with highlight creator 810 to place a highlight moment within the particular frame behind the white line.

Interface 800 may include video composition arrangement section 812 displaying the order of the derivative video segments (e.g., 702, 704, 706) selected for inclusion in a video segment. A user may change the order of the selected derivative video segments by moving the individual derivative video segments within video composition arrangement section 812. A user may deselect one or more selected derivative video segments by removing the derivative video segment from video composition arrangement section 812.

Referring to FIG. 9, interface 900 may enable a user to preview a video composition to be generated by the computing device. Interface 900 may include viewing area 902 for viewing a preview of the video composition. Interface 900 may include frame viewing area 906 that shows previews of the individual video frames of the video composition. Position of the highlight moments within the video composition may be indicated by highlight indicator 906. Interface 900 may include highlight selection menu 910. Highlight selection menu 910 may enable a user to jump to a location of a highlight moment within the video composition. For example, in FIG. 9, the video composition may include three highlight moments. A user may be able to jump to a location of one or the three highlight moments by selecting one of the three highlight icons in highlight selection menu 910. A user may approve the video composition for generation by the computing device by interacting with approval button 912.

In some implementations, the computing device may set/change one or more portions of the video content comprised in one or more video segments included in the video composition. The computing device may determine the amount of the video content comprised in the video segments based on metadata of the video content and/or other information. For example, the computing device may set/change the amount of the video content comprised in the video segments based on the duration of the video content, the motion/orientation of the camera that captured the video content, the number of derivative video segments/highlight moments selected for inclusion in the video composition, the music/song to which the video composition is to be synced, and/or other information.

For example, a user may have viewed previews of and selected for inclusion in a video composition derivative video segments corresponding to video segments 602 (containing highlight A 502), 604 (containing highlight B 504), 606 (containing highlight C 506) shown in FIG. 5B. Based on metadata of video 500 (or one or more portions of video 500), the computing device may change the portions of the video content comprised in the selected video segments so that video information defining video segment 612 is obtained for highlight A 502, video information defining video segment 614 is obtained for highlight B 504, and video information defining video segment 616 is obtained for highlight C 506.

As another example, a user may choose to sync a video composition to a music having a duration of 12 seconds. A user may have selected three derivative video segments/highlight moments for inclusion in the video composition. The computing device may request video information defining the corresponding three video segments such that the three video segments have a total play duration of 12 seconds. In some implementations, the computing device may change the play speed of one or more portions of the video segments (e.g., slow down, speed up, speed ramp).

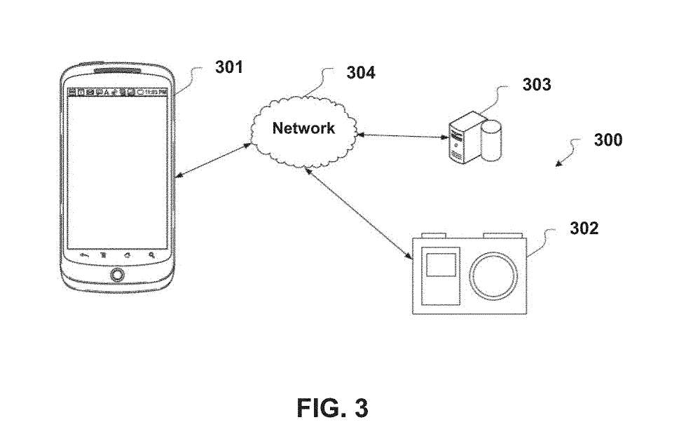

Referring to FIG. 3, exemplary system 300 may include including computing devices 301, 302, one or more servers 303, and network 304. Server(s) 303 may be configured to communicate with computing devices 301, 302 through network 304. Server(s) 303 may communicate with computing devices 301, 302 according to a client/server architecture. Server(s) 303 may provide one or more processing functionalities disclosed herein for creating video compositions. Server(s) 303 may provide for cloud computing and/or cloud storage for creating video compositions. Server(s) 303 may provide one or more functionalities of access component 102, highlight moment component 104, video segment component 106, derivative video segment component 108, communication component 110, and/or other components disclosed herein.

For example, video information defining video content may be accessed by server(s) 303. Server(s) 303 may identify one or more highlight moments in the video content. Server(s) 303 may identify one or more video segments in the video content based on the one or more highlight moments. Server(s) 303 may generate derivative video information defining one or more derivative video segments based on the one or more video segments. Server(s) 303 may transmit the derivative video information over network 304 to one or more computing devices 301, 302. One or more selections of the derivative video segments may be received from the computing device(s) 301, 302. Server(s) 303 may transmit video information defining one or more video segments corresponding to the one or more selected derivative video segments to the computing device(s) 301, 302. The computing device(s) 301, 302 may generate video composition information defining a video composition based on the received video information defining the one or more video segments corresponding to the one or more selected derivative video segments.

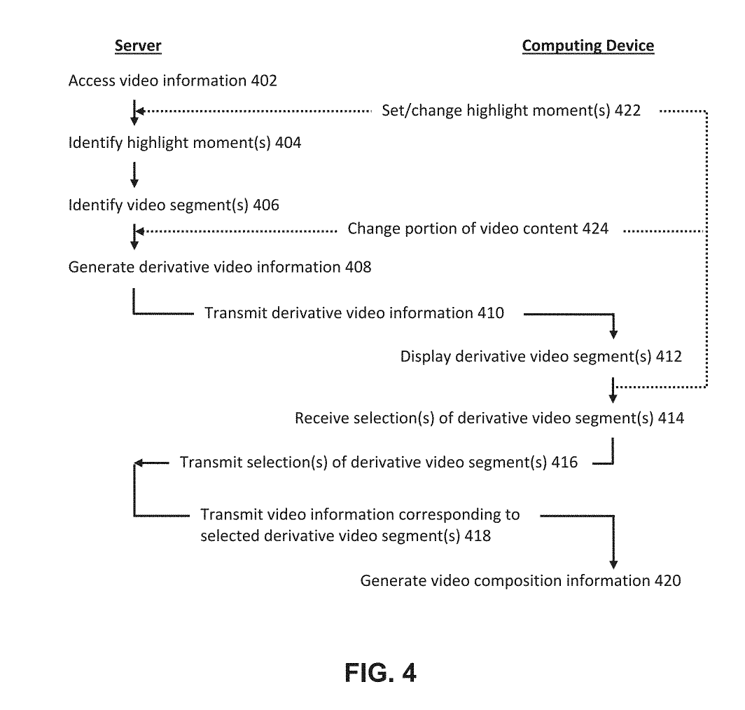

FIG. 4 illustrates exemplary process flows of a server (e.g., server(s) 303) and a computing device (e.g., 301, 302) for creating video compositions. The server may access video information 402 defining video content. The server may identity highlight moment(s) 404 in the video content. The server may identify video segment(s) 406 in the video content based on the highlight moments. The server may generate derivative video information 408 defining derivative video segment(s) based on the video segment(s). The server may transmit the derivative video information 410 to the computing device. The computing device may display the derivative video segment(s) 412. The computing device may receive selection(s) of the derivative video segment(s) 414 for inclusion in a video composition. The computing device may transmit the selection(s) of the derivative video segment(s) 416 to the server. The server may transmit video information corresponding to the selected derivative video segment(s) to 418 the computing device. The computing device may generate video composition information 420 defining the video composition.

In some implementations, the computing device may set and/or change one or more highlight moment(s) 422 in the video content. The server may receive from the computing device the highlight moment(s) set and/or changed by the computing device and may identify highlight moment(s) 404 based on the highlight moment(s) set and/or changed by the computing device. In some implementations, the computing device may change the portion of the video content 424 that comprise the video segment(s). The server may receive from the computing device the change in the portion of the video content that comprise the video segment(s) and may generate derivative video information 408 based on the changed video segment(s).

The systems/methods disclosed herein may enable the user(s) to begin reviewing the video segments more quickly by receiving the derivative versions of the video segments than if the users received the video content. The systems/methods may enable the users to select video segments for inclusion in a video composition using the derivative versions of the video segments. The systems/methods may enable the user(s) to download just those portions of the video content that are selected for inclusion in the video composition.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer readable storage medium may include read only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

Although processor 11 and storage media 12 are shown to be connected to interface 13 in FIG. 1, any communication medium may be used to facilitate interaction between any components of system 10. One or more components of system 10 may communicate with each other through hard-wired communication, wireless communication, or both. For example, one or more components of system 10 may communicate with each other through a network. For example, processor 11 may wirelessly communicate with storage media 12. By way of non-limiting example, wireless communication may include one or more of radio communication, Bluetooth communication, Wi-Fi communication, cellular communication, infrared communication, or other wireless communication. Other types of communications are contemplated by the present disclosure.

Although processor 11 is shown in FIG. 1 as a single entity, this is for illustrative purposes only. In some implementations, processor 11 may comprise a plurality of processing units. These processing units may be physically located within the same device, or processor 11 may represent processing functionality of a plurality of devices operating in coordination. Processor 11 may be configured to execute one or more components by software; hardware; firmware; some combination of software, hardware, and/or firmware; and/or other mechanisms for configuring processing capabilities on processor 11.

It should be appreciated that although computer components are illustrated in FIG. 1 as being co-located within a single processing unit, in implementations in which processor 11 comprises multiple processing units, one or more of computer program components may be located remotely from the other computer program components.

The description of the functionality provided by the different computer program components described herein is for illustrative purposes, and is not intended to be limiting, as any of computer program components may provide more or less functionality than is described. For example, one or more of computer program components 102, 104, 106, 108, and/or 110 may be eliminated, and some or all of its functionality may be provided by other computer program components. As another example, processor 11 may be configured to execute one or more additional computer program components that may perform some or all of the functionality attributed to one or more of computer program components 102, 104, 106, 108, and/or 110 described herein.

The electronic storage media of storage media 12 may be provided integrally (i.e., substantially non-removable) with one or more components of system 10 and/or removable storage that is connectable to one or more components of system 10 via, for example, a port (e.g., a USB port, a Firewire port, etc.) or a drive (e.g., a disk drive, etc.). Storage media 12 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. Storage media 12 may be a separate component within system 10, or storage media 12 may be provided integrally with one or more other components of system 10 (e.g., processor 11). Although storage media 12 is shown in FIG. 1 as a single entity, this is for illustrative purposes only. In some implementations, storage media 12 may comprise a plurality of storage units. These storage units may be physically located within the same device, or storage media 12 may represent storage functionality of a plurality of devices operating in coordination.

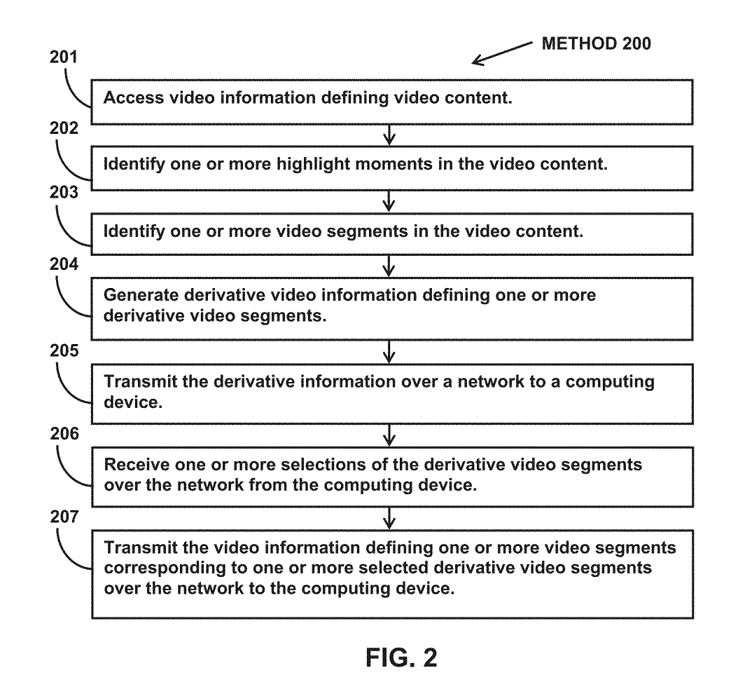

FIG. 2 illustrates method 200 for creating video compositions. The operations of method 200 presented below are intended to be illustrative. In some implementations, method 200 may be accomplished with one or more additional operations not described, and/or without one or more of the operations discussed. In some implementations, two or more of the operations may occur substantially simultaneously.

In some implementations, method 200 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operation of method 200 in response to instructions stored electronically on one or more electronic storage mediums. The one or more processing devices may include one or more devices configured through hardware, firmware, and/or software to be specifically designed for execution of one or more of the operation of method 200.

Referring to FIG. 2 and method 200, at operation 201, video information defining video content may be accessed. The video information may be stored in physical storage media. In some implementation, operation 201 may be performed by a processor component the same as or similar to access component 102 (Shown in FIG. 1 and described herein).

At operation 202, one or more highlight moments in the video content may be identified. One or more highlight moments may include a first highlight moment. In some implementations, operation 202 may be performed by a processor component the same as or similar to highlight moment component 104 (Shown in FIG. 1 and described herein).

At operation 203, one or more video segments in the video content may be identified based on one or more highlight moments. Individual video segments may comprising a portion of the video content including one or more highlight moments. One or more video segments may include a first video segment. The first video segment may comprise a first portion of the video content including the first highlight moment. In some implementations, operation 203 may be performed by a processor component the same as or similar to video segment component 106 (Shown in FIG. 1 and described herein).

At operation 204, derivative video information defining one or more derivative video segments may be generated. Derivative video information may be generated based on the one or more video segments. Individual derivative video segments may correspond to and may be generated from individual video segments. Individual derivative video segments may be characterized by lower fidelity than the corresponding individual video segments. One or more derivative video segments may include a first derivative video segment. The first derivative video segment may correspond to and may be generated from the first video segment. The first derivative video segment may be characterized by lower fidelity than the first video segment. In some implementations, operation 204 may be performed by a processor component the same as or similar to derivative video segment component 108 (Shown in FIG. 1 and described herein).

At operation 205, the derivative video information defining one or more derivative video segments may be transmitted over a network to a computing device. In some implementations, operation 205 may be performed by a processor component the same as or similar to communication component 110 (Shown in FIG. 1 and described herein).

At operation 206, one or more selections of the derivative video segments may be received over the network from the computing device. In some implementations, operation 206 may be performed by a processor component the same as or similar to communication component 110 (Shown in FIG. 1 and described herein).

At operation 207, the video information defining one or more video segments corresponding to one or more selected derivative video segments may be transmitted over the network to the computing device. The computing device may generate video composition information defining a video composition based on the video information defining one or more video segments corresponding to one or more selected derivative video segments. In some implementations, operation 207 may be performed by a processor component the same as or similar to communication component 110 (Shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A system for creating video compositions, the system comprising:
physical storage media storing video information defining video content;
one or more physical processors configured by machine-readable instructions to:
access the video information defining the video content;
identify one or more highlight moments in the video content, the one or more highlight moments including a first highlight moment;
identify one or more video segments in the video content based on the one or more highlight moments, individual video segments comprising a portion of the video content including at least one of the one or more highlight moments, wherein the one or more video segments include a first video segment comprising a first portion of the video content including the first highlight moment;
generate derivative video information defining one or more derivative video segments based on the one or more video segments, individual derivative video segments corresponding to and generated from the individual video segments, the individual derivative video segments characterized by lower fidelity than the corresponding individual video segments, wherein the one or more derivative video segments include a first derivative video segment corresponding to and generated from the first video segment, the first derivative video segment characterized by lower fidelity than the first video segment;
transmit over a network the derivative video information defining the one or more derivative video segments to a computing device;
receive over the network one or more selections of the derivative video segments from the computing device; and
transmit over the network the video information defining one or more of the video segments corresponding to the one or more selected derivative video segments to the computing device, the computing device generating video composition information defining a video composition based on the video information defining the one or more of the video segments corresponding to the one or more selected derivative video segments.

2. The system of claim 1, wherein lower fidelity includes one or more of lower resolution, lower framerate, and/or higher compression.

3. The system of claim 1, wherein transmitting the derivative video information to the computing device includes streaming the derivative video segments to the computing device.

4. The system of claim 1, wherein the first highlight moment is identified based on a highlight indication set during capture of the video content.

5. The system of claim 1, wherein the first highlight moment is changed based on a user interaction with the computing device.

6. The system of claim 1, wherein the first highlight moment is identified based on metadata characterizing capture of the video content.

7. The system of claim 1, wherein the video composition information is generated by the computing device further based on an ordering of the one or more selected derivative video segments, the ordering of the one or more selected derivative video segments determined based on a user interaction with the computing device.

8. The system of claim 1, wherein the portion of the video content comprised in at least one of the one or more video segments is changed based on a user interaction with the computing device.

9. The system of claim 1, wherein the video composition is changed based on a user interaction with the computing device and the video information defining one or more of the video segments corresponding to the one or more selected derivative video segments and transmitted to the computing device.

10. A method for creating video compositions, the method comprising:
accessing video information defining video content, the video information stored in physical storage media;
identifying one or more highlight moments in the video content, the one or more highlight moments including a first highlight moment;
identifying one or more video segments in the video content based on the one or more highlight moments, individual video segments comprising a portion of the video content including at least one of the one or more highlight moments, wherein the one or more video segments include a first video segment comprising a first portion of the video content including the first highlight moment;
generating derivative video information defining one or more derivative video segments based on the one or more video segments, individual derivative video segments corresponding to and generated from the individual video segments, the individual derivative video segments characterized by lower fidelity than the corresponding individual video segments, wherein the one or more derivative video segments include a first derivative video segment corresponding to and generated from the first video segment, the first derivative video segment characterized by lower fidelity than the first video segment;
transmitting over a network the derivative video information defining the one or more derivative video segments to a computing device;
receiving over the network one or more selections of the derivative video segments from the computing device; and
transmitting over the network the video information defining one or more of the video segments corresponding to the one or more selected derivative video segments to the computing device, the computing device generating video composition information defining a video composition based on the video information defining the one or more of the video segments corresponding to the one or more selected derivative video segments.

11. The method of claim 10, wherein lower fidelity includes one or more of lower resolution, lower framerate, and/or higher compression.

12. The method of claim 10, wherein transmitting the derivative video information to the computing device includes streaming the derivative video segments to the computing device.

13. The method of claim 10, wherein the first highlight moment is identified based on a highlight indication set during capture of the video content.

14. The method of claim 10, wherein the first highlight moment is changed based on a user interaction with the computing device.

15. The method of claim 10, wherein the first highlight moment is identified based on metadata characterizing capture of the video content.

16. The method of claim 10, wherein the video composition information is generated by the computing device further based on an ordering of the one or ore selected derivative video segments, the ordering of the one or more selected derivative video segments determined based on a user interaction with the computing device.

17. The method of claim 10, wherein the portion of the video content comprised in at least one of the one or more video segments is changed based on a user interaction with the computing device.

18. The method of claim 10, wherein the video composition is changed based on a user interaction with the computing device and the video information defining one or more of the video segments corresponding to the one or more selected derivative video segments.

19. A system for creating video compositions, the system comprising:
physical storage media storing video information defining video content;
one or more physical processors configured by machine-readable instructions to:
access the video information defining the video content;
identify one or more highlight moments in the video content, the one or more highlight moments including a first highlight moment; *
identify one or more video segments in the video content based on the one or more highlight moments, individual video segments comprising a portion of the video content including at least one of the one or more highlight moments, wherein the one or more video segments include a first video segment comprising a first portion of the video content including the first highlight moment;
generate derivative video information defining one or more derivative video segments based on the one or more video segments, individual derivative video segments corresponding to and generated from the individual video segments, the individual derivative video segments characterized by lower fidelity than the corresponding individual video segments, wherein lower fidelity includes one or more of lower resolution, lower framerate, and/or higher compression and the one or more derivative video segments include a first derivative video segment corresponding to and generated from the first video segment, the first derivative video segment characterized by lower fidelity than the first video segment;
transmit over a network the derivative video information defining the one or more derivative video segments to a computing device;
receive over the network one or more selections of the derivative video segments from the computing device; and
transmit over the network the video information defining one or more of the video segments corresponding to the one or more selected derivative video segments to the computing device, the computing device generating video composition information defining a video composition based on the video information defining the one or more of the video segments corresponding to the one or more selected derivative video segments and an ordering of the one or more selected derivative video segments, the ordering of the one or more selected derivative video segments determined based on a first user interaction with the computing device.

20. The system of claim 19, wherein the video composition is changed based on a second user interaction with the computing device and the video information defining one or more of the video segments corresponding to the one or more selected derivative video segments.
